(19) United States
(12) Patent Application Publication
(10) Pub. No.: US 2017/0148559 A1
(43) Pub. Date: May 25, 2017

(54) HIGH Q-FACTOR INDUCTOR STRUCTURE AND RF INTEGRATED CIRCUIT INCLUDING THE SAME

(71) Applicant: SK hynix Inc., Gyeonggi-do (KR)

(72) Inventor: Jung Hun CHOI, Busan (KR)

(21) Appl. No.: 15/076,315

(22) Filed: Mar. 21, 2016

(30) Foreign Application Priority Data
Nov. 23, 2015 (KR) 10-2015-0163848

(51) Int. Cl. H01F 27/28

(52) U.S. Cl. CPC H01F 27/2804

(57) ABSTRACT

High Q-factor inductor structures and RF integrated circuits including the same are provided. The inductor structure includes an inductor line disposed over an insulation layer, an upper metal line disposed over the insulation layer and spaced apart from the inductor line by a predetermined distance, first and second lower metal lines each disposed in the insulation layer and located at different levels from each other in a vertical direction, a lower via coupling the first lower metal line to the second lower metal line, a first upper via coupling the second lower metal line to the inductor line, and a second upper via coupling the second lower metal line to the upper metal line.

### CROSS-REFERENCE TO RELATED APPLICATION

The present application claims priority under 35 U.S.C 119(a) to Korean Patent Application No. 10-2015-0163848, filed on Nov. 23, 2015, which is herein incorporated by reference in its entirety.

### BACKGROUND

1. Technical Field

Various embodiments of the present disclosure relate to inductor structures and RF integrated circuits including the same and, more particularly, to high Q-factor inductor structures and RF integrated circuits including the same.

2. Related Art

Recently, with the development of portable communication technology, development of RF integrated circuits has been actively carried out using the silicon complementary metal oxide (CMOS) technology. The overall performance of the RF integrated circuit has been greatly improved by miniaturization of the CMOS process and high performance of MOS devices. However, there is a limit in improving the overall performance of the RF integrated circuit only by relying on the high performance of the MOS devices. This is because a number of analog passive devices, such as on chip inductor devices, are included in the RF integrated circuit.

An inductor may be characterized by its inductance and a quality-factor (Q-factor). The inductance depends on parameters such as the length and the number of turns of a conductive line. The Q-factor depends on the resistance of the conductive line. That is, the Q-factor increases as the resistance of the conductive line decreases. However, a standard inductor, which has a single-layer conductive line, shows a low Q-factor due to the high resistance of a lower conductive layer used to couple an end portion of the conductive line to another conductive layer.

### SUMMARY

Various embodiments are directed to high-Q factor inductor structures and RF integrated circuits including the same. According to an embodiment, an inductor structure includes an Inductor line disposed over an insulation layer, an upper metal line disposed over the insulation layer and spaced apart from the inductor line by a predetermined distance, first and second lower metal lines each disposed in the insulation layer and located at different levels from each other in a vertical direction, a lower via coupling the first lower metal line to the second lower metal line, a first upper via coupling the second lower metal line to the inductor line, and a second upper via coupling the second lower metal line to the upper metal line.

According to another embodiment, an inductor structure includes an inductor line disposed over an insulation layer, an upper metal line disposed over the insulation layer and spaced apart from the inductor line by a predetermined distance, first, second, and third lower metal lines disposed in the insulation layer and located at different levels from each other in a vertical direction, a first-level lower via coupling the first lower metal line to the second lower metal line, a second-level lower via coupling the second lower metal line to the third lower metal line, a first upper via coupling the third lower metal line to the inductor line, and a second upper via coupling the third lower metal line to the upper metal line.

According to another embodiment, an RF integrated circuit includes a substrate including a first region and a second region, an inductor structure disposed over the substrate of the first region, a semiconductor device disposed over the substrate of the second region, and a wiring structure coupling the inductor structure to the semiconductor device. The inductor structure includes an inductor line disposed over the substrate in the first region, an upper metal line disposed over the substrate in the first region and spaced apart from the inductor line by a predetermined distance, a plurality of lower metal lines located at different levels from each other in a vertical direction, wherein the plurality of lower metal lines includes an uppermost lower metal line which is located at the highest level among the plurality of lower metal lines, lower vias coupling the plurality of lower metal lines to each other, a first upper via coupling the uppermost lower metal line to the inductor line, and a second upper via coupling the uppermost lower metal line to the upper metal line.

### BRIEF DESCRIPTION OF THE DRAWINGS

Various embodiments of a present disclosure will become more apparent in view of the attached drawings and accompanying detailed description, in which:

FIG. 1 is a top plan view illustrating an inductor structure according to an exemplary embodiment;

FIG. 2 is a cross-sectional view taken along I-I′ line in FIG. 1;

FIG. 3 is a circuit diagram illustrating the equivalent resistance of the inductor structure of FIG. 2;

FIG. 4 is a cross-sectional view taken along I-I′ line in FIG. 1; and

FIG. 5 is a cross-sectional view illustrating an RF integrated circuit according to an exemplary embodiment.

### DETAILED DESCRIPTION OF THE EMBODIMENTS

In the following description of the embodiments, it will be understood that the terms “first” and “second” are intended to identify an element, but not used to define only the element itself or to mean a particular sequence. In addition, when an element is referred to as being located “on”, “over”, “above”, “under” or “beneath” another element, it is intended to mean a relative position relationship, but not used to limit certain cases that the element directly contacts the other element, or at least one intervening element is present therebetween. Accordingly, terms such as “on”, “over”, “above”, “under”, “beneath”, “below” and the like that are used herein are for the purpose of describing particular embodiments only and are not intended to limit the scope of the present disclosure. Further, when an element is referred to as being “connected” or “coupled” to another element, the element may be electrically or mechanically connected or coupled to the other element directly, or may form a connection relationship or coupling relationship by replacing the other element therebetween.

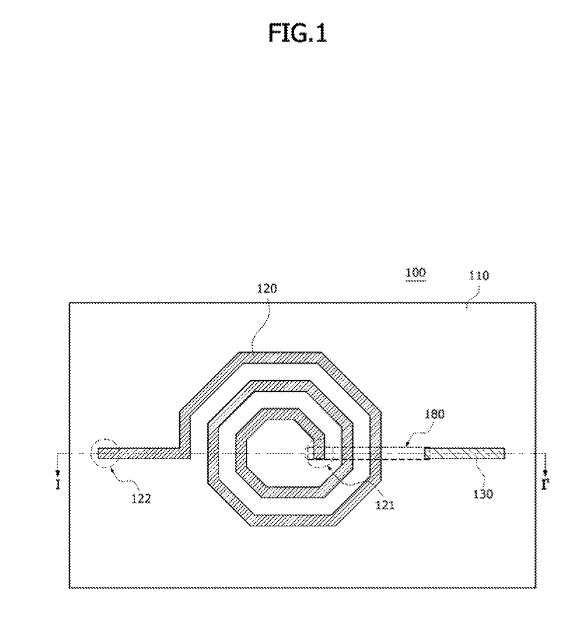

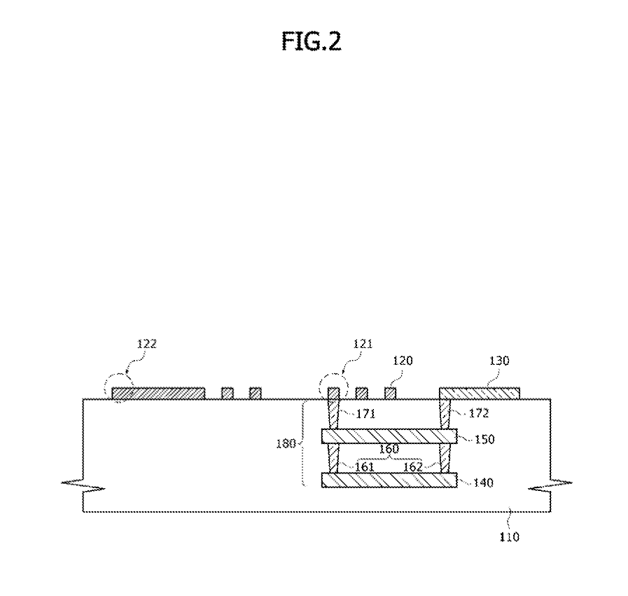

FIG. 1 is a top plan view illustrating an inductor structure 100 according to an exemplary embodiment. FIG. 2 is a cross-sectional view illustrating the inductor structure 100 taken along I-I′ line in FIG. 1.

Referring to FIGS. 1 and 2, the inductor structure 100 includes an inductor line 120 disposed on an Insulation layer 110. The inductor line 120 may be formed of a metal line, and have a spiral polygon shape when viewed from the top. The inductor line 120 has a planar structure.

Therefore, a lower surface of the inductor line 120 directly contacts an upper surface of the insulation layer 110. The inductor line 120 includes a first end portion 121 and a second end portion 122, which correspond to both terminals of an inductor. The first end portion 121 and the second end portion 122 may be opposite end portions and located in the inner and outer portions of the inductor line 1201n a spiral shape, respectively.

The inductor line 120 has a standard inductor structure, that is, an octagon shape. The inductor line 120 may be formed in a stripe loop shape. A contour of the inductor line 120 may form a circle, a square, or a hexagon. The inductor line 120 may have an Inductor structure employing a patterned ground shield (PGS) which suppresses eddy current generated in a general silicon substrate having a very low resistivity of about 1-3Ω. The inductor line 120 may have a stack inductor structure capable of realizing a higher inductance in a given area. The inductor line 120 may have a multi-layer inductor structure having an increased effective thickness of a metal layer by connecting two metal layers in parallel.

An upper metal line 130 is disposed on the insulation layer 110. The upper metal line 130 is spaced apart from the inductor line 120 by a predetermined distance in the horizontal direction. The inductor line 120 and the upper metal line 130 are electrically coupled to each other by a connection structure 180 disposed in the insulation layer 110. The connection structure 180 includes a first lower metal line 140 and a second lower metal line 150, which are disposed in the insulation layer 110.

The first lower metal line 140 and the second lower metal line 150 are completely buried in the insulation layer 110. That is, a lower surface of the first lower metal line 140 is spaced apart from a lower surface of the insulation layer, and an upper surface of the second lower metal line 150 is spaced apart from an upper surface of the insulation layer 110. The first lower metal line 140 and the second lower metal line 150 are spaced apart from each other in a vertical direction. In an embodiment, the first lower metal line 140 and the second lower metal line 150 may be overlapped with each other in the vertical direction.

Both ends of the first lower metal line 140 and both ends of the second lower metal line 150 may align with each other in the vertical direction. An end portion of the first lower metal line 140 and an end portion of the second lower metal line 150 may be aligned with a first end portion 121 of the inductor line 120 in the vertical direction. The other end portions of the first lower metal line 140 and the second lower line 150 may be aligned with an end portion of the upper metal line 130 in the vertical direction.

A lower via 160 is disposed between the first lower metal line 140 and the second lower metal line 150. The lower via 160 is disposed in the insulation layer 110. The lower via 160 includes a first lower via 161 and a second lower via 162. The first lower via 161 is disposed between an upper surface of an end portion of the first lower metal line 140 and a lower surface of an end portion of the second lower metal line 150. That is, the lower and upper surfaces of the first lower via 161 directly contact the upper surface of an end portion of the first lower metal line 140 and the lower surface of an end portion of the second lower metal line 150, respectively.

The second lower via 162 is disposed between an upper surface of the other end portion of the first lower metal line 140 and a lower surface of the other end portion of the second lower metal line 150. That is, the lower and upper surfaces of the second lower via 162 directly contact the upper surface of the other end portion of the first lower metal line 140 and the lower surface of the other end portion of the second lower metal line 150, respectively. The lower via 160 electrically couples the first lower metal line 140 to the second lower metal line 150.

A first upper via 171 is disposed between an upper surface of an end portion of the second lower metal line 150 and a lower surface of the first end portion 121 of the inductor line 120. The first upper via 171 is disposed in the insulation layer 110. The lower and upper surfaces of the first upper via 171 directly contact the upper surface of an end portion of the second lower metal line 150 and the lower surface of the first end portion 121 of the inductor line 120, respectively.

A second upper via 172 is disposed between an upper surface of the other end portion of the second lower metal line 150 and a lower surface of an end portion of the upper metal line 130. The second upper via 172 is disposed in the insulation layer 110. The lower and upper surfaces of the second upper via 172 directly contact the upper surface of the other end portion of the second lower metal line 150 and the lower surface of an end portion of the upper metal line 130, respectively.

The first upper via 171 and the second upper via 172 electrically couple the second lower metal line 150 to the inductor line 120 and the upper metal line 130, respectively. The first lower via 161 may be aligned with the first upper via 171 in the vertical direction, and the second lower via 162 may be aligned with the second upper via 172 in the vertical direction.

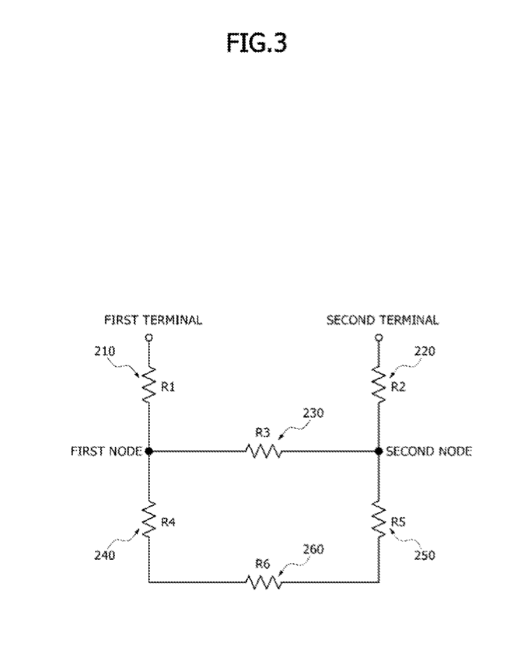

FIG. 3 is a circuit diagram illustrating the equivalent resistance of the inductor structure of FIG. 2. Referring to FIG. 3 together with FIG. 2, when the first end portion 121 of the inductor line 120, which contacts the first upper via 171, is set as a first terminal, and an end portion of the upper metal line 130, which contacts the second upper via 172, is set as a second terminal, resistance components consisting of the first lower metal line 140, the second lower metal line 150, the first lower via 161, the second lower via 162, the first upper via 171 and the second upper via 172 are formed between the first and second terminals.

A first resistor 210 having a first resistance R1 of the first upper via 171, a second resistor 220 having a second resistance R2 of the second upper via 172, and a third resistor 230 having a third resistance R3 of the second lower metal line 150 are connected to each other in series between the first and second terminals. A fourth resistor 240 having a fourth resistance R4 of the first lower via 161, a fifth resistor 250 having a fifth resistance R5 of the second lower via 162, and a sixth resistor 260 having a sixth resistance R6 of the first lower metal line 140 are connected to each other in series between a first node and a second node. The first node and the second node may be both terminals of the third resistor 230. The series-connected resistors 240-260 have the total resistance R4+R5+R6, which is the sum of the fourth resistance R4, the fifth resistance R5 and the sixth resistance R6. The series-connected resistors 240-260 have the total resistance R4+R5+R6. The third resistor 230 having the third resistance R3 is in a parallel connection with the series-connected resistors 240-260.

In the case of the conventional inductor structure that does not have the fourth resistor 240, the fifth resistor 250 and the sixth resistor 260, the total resistance between the first and second terminals becomes R1+R2+R3, which is the sum of the first, second and third resistance R1, R2 and R3. However, in the embodiment, since the fourth resistor 240, the fifth resistor 250 and the sixth resistor 260 exist, the total resistance between the first and second terminals becomes R1+R2+R_{eq}, which is the sum of the first, second and equivalent resistance R₁, R₂ and R_{eq}.

The equivalent resistance R_{eq} may be calculated using the following equation.

1/R_{eq}=(1/R3)+(1/(R4+R5+R6))

The equivalent resistance R_{eq}, which is calculated using the above equation, has a value less than the third resistance R3 of the third resistor 230. Accordingly, the total resistance between the first node and the second node becomes lower compared with the conventional inductor which does not have the fourth resistor 240, the fifth resistor 250, and the sixth resistor 260. Thus, the Q-factor of the inductor becomes higher.

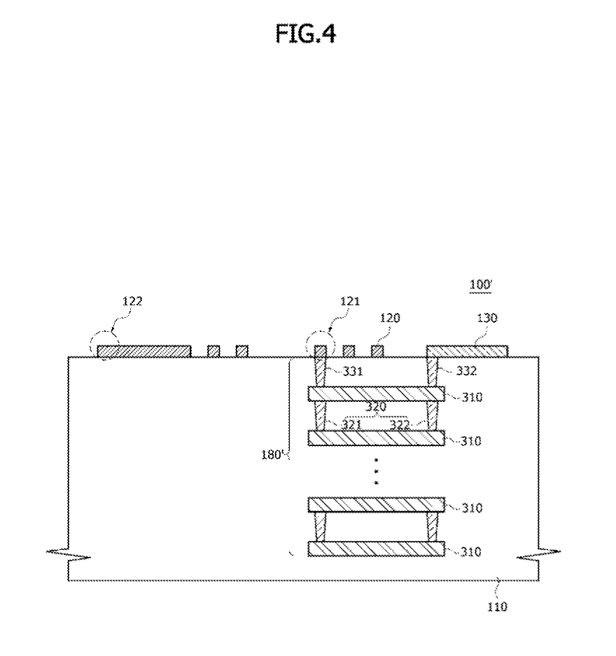

FIG. 4 is a view illustrating an inductor structure 100′ according to another exemplary embodiment. FIG. 4 is a cross-sectional view taken along I-I′ line in FIG. 1. The same reference numerals shown in FIG. 4 represent the same elements shown in FIGS. 1 and 2.

Referring to FIG. 4, the inductor structure 100′ according to the embodiment includes a connection structure 180′ which is disposed in the insulation layer 110 and electrically couples the inductor line 120 to the upper metal line 130. The inductor structure 100′ is the same as the inductor structure 100 of FIG. 2 except for the connection structure 180′.

The connection structure 180′ according to the embodiment includes a plurality of lower metal lines 310, for example three or more lower metal lines, disposed in the insulation layer 110. The lower metal lines 310 are spaced apart from each other in the vertical direction. The lower metal lines 310 are completely buried in the insulation layer 110. That is, a lower surface of the lowest lower metal line 310 is spaced apart from the lower surface of the insulation layer 110, and the upper surface of the uppermost lower metal line 310 is spaced apart from the upper surface of the insulation layer 110.

In an embodiment, the lower metal lines 310 may be overlapped with or aligned with each other in the vertical direction. Both ends of the lower metal lines 310 may be aligned with each other in the vertical direction. One end portion of each of the lower metal lines 310 may be aligned with the first end portion 121 of the inductor line 120 in the vertical direction. The opposite end portion of each of the lower metal lines 310 may be aligned with an end portion of the upper metal line 130 in the vertical direction.

Lower-level vias 320 are provided between the lower metal lines 310 to connect the lower metal lines 310 to each other. The lower-level vias 320 may include first, second, third lower-level vias 320 which are located at different levels from each other in the vertical direction.

The lower-level vias 320 are disposed in the insulation layer 110. Each of the lower-level vias 320 includes a first lower via 321 and a second lower via 322. The first lower via 321 is disposed between an upper surface of an end portion of one of the lower metal lines 310 and a lower surface of an end portion of another of the lower metal lines 310. The two lower metal lines 310 which are connected by first lower via 321 are located adjacent to each other in the vertical direction. That is, lower and upper surfaces of the first lower via 321 directly contact the upper surface of an end portion of a lower metal line 310, which is disposed at a lower level, and the lower surface of an end portion of a lower metal line 310, which is disposed at an upper level, respectively.

The second lower via 322 is disposed between an upper surface of the other end portion of the lower metal line 310, which is located at the lower level, and a lower surface of the other end portion of the lower metal lines 310, which is located at the upper level. That is, lower and upper surfaces of the second lower via 322 directly contact the upper surface of the other end portion of the lower metal line 310, which is disposed at the lower level, and the lower surface of the other end portion of the lower metal line 310, which is disposed at an upper level, respectively. The lower-level vias 320 electrically couple the lower metal lines 310 to each other in the vertical direction.

A first upper via 331 is disposed between a lower surface of an end portion of the uppermost lower metal line 310 and a lower surface of the first end portion 121 of the inductor line 120 in the insulation layer 110. That is, lower and upper surfaces of the first upper via 331 directly contact the upper surface of an end portion of the uppermost lower metal line 310 and the lower surface of the first end portion 121 of the inductor line 120.

A second upper via 332 is disposed between the upper surface of the other end portion of the uppermost lower metal line 310 and the lower surface of an end portion of the upper metal line 130 in the insulation layer 110. That is, lower and upper surfaces of the second upper via 332 directly contact the upper surface of the other end portion of the uppermost lower metal line 310 and the lower surface of an end portion of the upper metal line 130, respectively.

The first upper via 331 and the second upper via 332 electrically couple the uppermost lower metal line 310 to the inductor line 120 and the upper metal line 130, respectively. The first lower via 321 may be aligned with the first upper via 331 in the vertical direction, and the second lower via 322 may be aligned with the second upper via 332 in the vertical direction.

In the inductor structure 100′ according to the embodiment, a resistance component of the first upper via 331, a resistance component of the second upper via 332, and a resistance component of the uppermost lower metal line 310 are present between the first end portion 121 of the inductor line 120, which contacts the first upper via 331, and an end portion of the upper metal line 130, which contacts the second upper via 332. A resistance component of the lower metal line 310 disposed below the uppermost lower metal line 310, a resistance component of the first lower via 321, and a resistance component of the second lower via 322 are disposed in parallel between both end portions of the uppermost lower metal line 310.

Similarly, a resistance component of the lower metal line 310 disposed below the lower metal line 310, a resistance component of the first lower via 321, and a resistance component of the second lower via 322 are disposed in parallel between both end portions of one of the lower metal lines 310. The connection structure 180′ is provided between the first end portion 121 of the inductor line 120 and an end portion of the upper metal line 130 which contacts the second upper via 332. The connection structure 180′ includes a plurality of resistance components connected in parallel. Accordingly, the equivalent resistance of the whole connection structure 180′ becomes lower than when there is only the uppermost lower metal line 310. The low equivalent resistance of the whole connection structure 180′ increases the Q-factor of the inductor structure 100′.

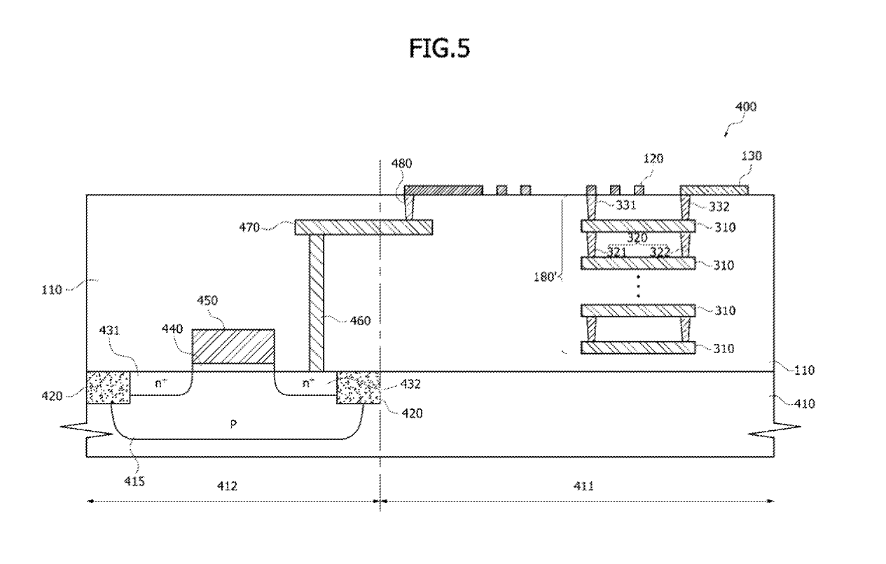

FIG. 5 is a cross-sectional view illustrating an RF integrated circuit 400 according to an embodiment. Referring to FIG. 5, the RF integrated circuit 400 includes an insulation layer 110 disposed on a substrate 410. The substrate 410 includes a first region 411 and a second region 412. The first region 411 may be defined as a region in which an inductor structure is disposed. The second region 412 may be defined as a region in which active semiconductor devices, such as transistors, are disposed. The inductor structure is disposed on the insulation layer 110 in the first region 411 of the substrate 410, and includes a connection structure 180′ buried in the insulation layer 110. The connection structure 180′ shown in FIG. 5 has the same structure as the connection structure 180′ described above with reference to FIG. 4. Accordingly, duplicate descriptions of the connection structure 180′ will be omitted.

The semiconductor device may be disposed in or on the second region 412 of the substrate 410. In some embodiments, the semiconductor device may be an N-channel MOS transistor. In some embodiments, the semiconductor device may be a P-channel MOS transistor, or a complementary MOS (CMOS) transistor which includes both of the N-channel MOS (NMOS) transistor and P-channel MOS (PMOS) transistor. When the semiconductor device is the N-channel MOS transistor, a P-type well region 415 is disposed at an upper region of the substrate 410 of the second region 412. An active region is disposed at an upper region of the P-type well region 415, and the active region may be defined by a trench device isolation layer 420. An N⁺-type source region 431 and an N⁺-type drain region 432 are disposed in the active region and spaced apart from each other by the channel region. A gate insulation layer 440 and a gate electrode layer 450 are sequentially disposed on the channel region.

The N⁺-type drain region 432 may be electrically coupled to a second end portion of the inductor line 120 through a drain contact plug 460, a metal wiring layer 470 and a via 480. A drain terminal of the N-channel MOS transistor is electrically coupled to a terminal of the inductor structure. The N-channel MOS transistor may be used as a switching device. In this case, the switching device and the inductor structure may be connected to each other in series. As described above with reference to FIG. 4, the inductor structure connected to the switching device in series may have a high Q-factor, and thus the RF integrated circuit 400 according to the embodiment may provide improved frequency characteristics.

Embodiments of the present disclosure have been disclosed above for illustrative purposes. Those skilled in the art will appreciate that various modifications, additions and substitutions are possible, without departing from the scope and spirit of the present disclosure as disclosed in the accompanying claims.

What is claimed is:

1. An Inductor structure comprising:
an inductor line disposed over an insulation layer;
an upper metal line disposed over the insulation layer and spaced apart from the inductor line by a predetermined distance;
first and second lower metal lines each disposed in the insulation layer and located at different levels from each other in a vertical direction;
a lower via coupling the first lower metal line to the second lower metal line;
a first upper via coupling the second lower metal line to the inductor line; and
a second upper via coupling the second lower metal line to the upper metal line.

2. The Inductor structure of claim 1, wherein the inductor line includes a metal line in a spiral shape, and
wherein the inductor line has a contour in a polygon shape.

3. The inductor structure of claim 2, wherein the first lower metal line and the second lower metal line are aligned with each other in the vertical direction.

4. The inductor structure of claim 3, wherein both ends of the first lower metal line and both ends of the second lower metal line are aligned with each other in the vertical direction.

5. The inductor structure of claim 2,
wherein the lower via comprises a first lower via and a second lower via,
wherein a first lower via is disposed between a first end of the first lower metal line and a first end of the second lower metal line, and
wherein a second lower via is disposed between a second end of the first lower metal line and a second end of the second lower metal line.

6. The inductor structure of claim 5, wherein the first lower via is aligned with the first upper via in the vertical direction, and
wherein the second lower via is aligned with the second upper via in the vertical direction.

7. The inductor structure of claim 2,
wherein the first upper via is disposed between a first end of the second lower metal line and a first end of the inductor line, and
wherein the second upper via is disposed between a second of the second lower metal line and a first end of the upper metal line.

8. An inductor structure comprising:
an inductor line disposed over an insulation layer;
an upper metal line disposed over the Insulation layer and spaced apart from the Inductor line by a predetermined distance;
first, second, and third lower metal lines disposed in the insulation layer and located at different levels from each other in a vertical direction;
a first-level lower via coupling the first lower metal line to the second lower metal line;
a second-level lower via coupling the second lower metal line to the third lower metal line;
a first upper via coupling the third lower metal line to the inductor line; and
a second upper via coupling the third lower metal line to the upper metal line.

9. The inductor structure of claim 8, wherein the Inductor line includes a metal line in a spiral shape, and
wherein the inductor line has a contour in a polygon shape.

10. The Inductor structure of claim 9, wherein the first, the second and the third lower metal lines are aligned with each other in the vertical direction.

11. The inductor structure of claim 10, wherein both ends of each of the first, the second, and the third lower metal lines are aligned with each other in the vertical direction.

12. The inductor structure of claim 9, wherein each of the first-level lower via and the second-level lower via includes first and second lower vias,
wherein the first lower via of the first-level lower via extends between a first end of the first lower metal line and a first end of the second lower metal line, wherein the second lower via of the first-level lower via extends between a second end of the first lower metal line and a second end of the second lower metal line,
wherein the first lower via of the second-level lower via extends between the first end of the second lower metal line and a first end of the third lower metal line, and
wherein the second lower via of the second-level lower via extends between the second end of the second lower metal line and a second end of the third lower metal line.

13. The inductor structure of claim 12, wherein the first lower via of the second-level lower via is aligned with the first upper via in the vertical direction,
wherein the first lower via of the first-level lower via is aligned with the first upper via in the vertical direction,
wherein the second lower via of the second-level lower via is aligned with the second upper via in the vertical direction, and
wherein the second lower via of the first-level lower via is aligned with the second upper via in the vertical direction.

14. The inductor structure of claim 8,
wherein the first lower metal line is located at a lower level than the second lower metal line,
wherein the second lower metal line is located at a lower level than the third lower metal line,
wherein the first upper via is disposed between a first end of the third lower metal line and a first end of the inductor line, and
wherein the second upper via is disposed between a second end of the third lower metal line and a first end of the upper metal line.
